(19) United States
(12) Patent Application Publication
(10) Pub. No.: US 2022/0134153 A1
(43) Pub. Date: May 5, 2022

(54) SYSTEM FOR EXTINGUISHING A FIRE AND / OR PREVENTING THE TAKING OR RESUMPTION OF AN ELECTRIC VEHICLE FIRE, ASSOCIATED OPERATING METHOD

(71) Applicant: COMMISSARIAT A L'ENERGIE ATOMIQUE ET AUX ENERGIES ALTERNATIVES, Paris (FR)

(72) Inventor: Rémi VINCENT, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/453,230

(22) Filed: Nov. 2, 2021

(30) Foreign Application Priority Data
Nov. 2, 2020 (FR) 20 11225

(51) Int. Cl. A62C 3/07; A62C 3/16

(52) U.S. Cl. CPC A62C 3/07; A62C 3/16

(57) ABSTRACT

A system for extinguishing a fire and/or preventing a fire from starting or restarting in an electric vehicle, associated method of operation including a prior step of lifting the vehicle off the ground. In particular, the system for extinguishing the fire and/or preventing the fire from starting or restarting in the electric vehicle, which incudes, a module or a battery pack comprising a plurality of electrochemical batteries, in particular metal-ion batteries, includes a self-supporting inflatable structure, the shape and dimensions of which when deployed are adapted to create a peripheral barrier, which is closed upon itself, around the electric vehicle; and a liquid supply device for filling, at least partially, the volume delimited inside the peripheral barrier, so as to immerse at least the module or battery pack in the liquid.

### TECHNICAL FIELD

The present invention relates to the field of electric vehicles.

The main aim of the invention is to extinguish a fire and/or prevent a fire from restarting in an electric vehicle including a module or a battery pack with several electrochemical batteries, more particularly metal-ion batteries. Use of the invention preventatively, to reduce the risk of a fire starting in an electric vehicle, in particular accidentally, is also possible.

Although described with reference to a lithium-ion battery, the invention also applies to any metal-ion electrochemical battery, i.e. also to sodium-ion, magnesium-ion, aluminum-ion, etc. batteries, or more generally to any electrochemical battery.

In this document and in the context of the invention, “electric vehicle” means any motor vehicle with electric or hybrid propulsion, including at least one module or battery pack with several electrochemical batteries, more particularly metal-ion batteries.

### PRIOR ART

In the development and manufacture of lithium-ion batteries, for each new request/profile, whichever market operators are involved, precise specifications are necessary (series/parallel electrical, mechanical, thermal, etc. architectures) to ensure optimal design of a high-performance, safe battery pack.

In particular, consideration must be given to the safety of lithium-ion batteries at all levels, whether battery alone, module or battery pack.

Various passive or active safety devices may also be included in a cell (battery), and/or a module and/or a battery pack to prevent problems, when the battery malfunctions or a cell fails.

A lithium electrochemical system, whether at the level of the cell (battery), module or pack, produces exothermic reactions whatever the cycling profile in question. Thus, in the case of a single battery, depending on the chemistry involved, optimal operation of lithium-ion batteries is limited within a given temperature range.

An electrochemical battery must operate within a defined temperature range, typically generally below 70° C. on the external surface of the housing, so as not to impair performance, or indeed to prevent physical damage or even destruction.

Examples include lithium iron phosphate batteries which have an operating range generally between −20° C. and +60° C. Above 60° C., the materials can suffer considerable damage, impairing the performance of the cell. Above a temperature referred to as the thermal runaway temperature, which may be between 70° C. and 110° C., exothermic internal chemical reactions are triggered. When the battery is no longer capable of discharging heat sufficiently, the temperature of the cell increases until it is destroyed, this usually being referred to as thermal runaway.

In other words, thermal runaway occurs in a cell (battery) when the energy given off by the exothermic reactions happening inside the cell exceeds its capacity to dissipate this energy. Thermal runaway may be followed by the generation of gas and explosion and/or fire. There have already been a number of cases of fires in electric vehicles including a battery, or battery pack with several lithium-ion batteries, which have proved particularly difficult to bring under control.

This is mainly due to the fire restarting, sometimes several hours after it was extinguished. For example, take the recent case of an electric vehicle which caught fire in a garage. The fire was put out by fire fighters. Around 4.5 hours later, the fire started again when the vehicle was being loaded onto the recovery vehicle.

A fire restarting is generally caused by components of the battery (modules or batteries (cells)) which have been electrically disconnected but still contain charge. Thus, randomly, for example when the damaged vehicle is moved, these components can produce electrical arcs that can start another fire.

To avoid such a situation, it is necessary to find a solution that ensures, when the fire is extinguished, that the module or battery pack of an electric vehicle is fully electrically discharged.

The aim of the invention is to at least partly meet this need.

### DESCRIPTION OF THE INVENTION

To this end, the invention relates, according to one aspect, to a system for extinguishing a fire and/or preventing a fire from starting or restarting in an electric vehicle including a module or a battery pack comprising a plurality of electrochemical batteries, in particular metal-ion batteries, comprising:
a self-supporting inflatable structure, the shape and dimensions of which when deployed are adapted to create a peripheral barrier which is closed upon itself, around the electric vehicle;
a liquid supply device for filling, at least partially, the volume delimited inside the peripheral barrier, so as to immerse at least the module or battery pack in the liquid.

According to one advantageous variant embodiment, the structure may be inflated with liquid and to this end it comprises at least one filling hole for filling with liquid for inflation.

Advantageously, the filling hole is adapted to be connected to the liquid supply device. According to one advantageous embodiment, the inflatable structure comprises a plurality of aligned flexible casings, each closed upon itself, in the form of sausages, the sausages being fluidly interconnected at the bottom, and deploying vertically when they are inflated. Advantageously, the sausages are spaced apart regularly, so as to ensure uniform inflation and hence a uniform barrier around the whole periphery thereof.

Also advantageously, the system comprises fastening means, such as fastening straps, arranged around the plurality of sausages closed upon itself, for mechanical retention and for forming the peripheral barrier.

Advantageously, the fastening means comprise covering sheets configured so as to cover at least partially the gaps between the sausages after they have been deployed.

According to another advantageous embodiment, the inflatable structure further comprises a flexible sealing sheet that extends from the bottom of the sausages and, in the installed configuration, toward the inside of the barrier. The seal may be created by a body of liquid inside the volume delimited by the barrier, which presses on the sheet, and the weight of the sausages. This sealing sheet is a surface that is particularly deformable under the sausages so as to follow the ground covering as closely as possible. A perfect seal is not necessary. The aim is to immerse the module or battery pack of the vehicle without having to move the vehicle, and it is enough that the rate of leakage is lower than the rate of intake of water.

Advantageously, the flexible sealing sheet is not continuous along the peripheral barrier. The flexible sealing sheet may extend along a curved line that is not closed upon itself. The flexible sealing sheet may thus be easily put in place around the vehicle without having to move the latter.

According to a particularly advantageous variant, at least some of the sausages comprise an outlet hole at the top, such that when they are deployed vertically, after being inflated with the liquid, this liquid fills, by overflowing from the sausages, the volume delimited inside the barrier.

The liquid for filling the sealed volume is advantageously water.

In this case, the system advantageously comprises salts that are soluble in water, placed beforehand in at least one area of the structure in the non-deployed state so that said salts are in contact with the water when the sealed volume (R) is filled.

Preferably, the inflatable structure is at least partially made of a fabric based on aramid fibers. Such a fabric is particularly suitable for making the structure flame-resistant, when it is installed.

Also preferably, the fabric is sealed, at least on the inside intended to be in contact with the liquid, by a polytetrafluoroethylene (PTFE) film.

The liquid supply device is advantageously a fire-fighting vehicle, in particular a tank truck, an emergency response vehicle. Thus, fire fighters responding to a fire in an electric vehicle have a completely autonomous system, as the inflatable structure can easily be loaded on board a vehicle and thus deployed very quickly on site.

The invention also relates to a method of operation of a system just described, comprising the following steps:
i/ positioning and closing upon itself the inflatable structure around an electric vehicle;
ii/ inflating the structure so as to create the peripheral barrier;
iii/ filling, with a liquid from the supply device, at least part of the volume delimited inside the peripheral barrier, so as to immerse at least the module or battery pack.

According to one advantageous embodiment, steps ii/ and iii/ are carried out one after the other using just the supply device, step iii/ being carried out by overflowing from the sausages of the structure once they have been inflated.

Advantageously, use is made of water, optionally containing salts, as inflation and filling liquid for both steps ii/ and iii/. Salts advantageously increase the conductivity of the water and thus ensure electrical discharge of the module or battery pack once immersed. To simplify the work of the emergency responders called to a fire, specifically the fire fighters, the salts may be contained directly in the inflatable structure, in particular the sausages, allowing, in the configuration in which water is used for inflation and then for filing the immersion volume, efficient dilution when the water is added.

Thus, the invention consists essentially of a system that extinguishes a fire in an electric vehicle and prevents any fire from starting or restarting by means of a self-supporting inflatable structure which, when inflated and closed upon itself, forms a barrier around the vehicle, with the internal volume delimited therein immersed in a liquid, ensuring that the the module or battery pack of the vehicle is electrically discharged.

The inflatable flexible structure allows the emergency responders, specifically the fire fighters, to avoid having to bring rigid retention containers, which are particularly bulky and require means for lifting the vehicle.

This structure becomes self-supporting when inflated, and is advantageously inflated using the same liquid from the supply device, which may fill the volume delimited by the barrier by overflowing from the structure deployed.

Some of the many advantages of the invention are:
a system which is simple, easy and quick to implement around an electric vehicle on fire;
an inflatable structure that can be loaded on board quickly and deployed quickly and easily from an emergency response vehicle, such as a tank truck or fire truck;
guaranteed extinction of the fire and prevention of the fire restarting owing to electrical discharge by virtue of the immersion of the module or battery pack of the electric vehicle.

Further advantages and features of the invention will emerge more clearly on reading the detailed description of embodiments of the invention, provided by way of non-limiting illustration with reference to the following figures.

### BRIEF DESCRIPTION OF THE DRAWINGS

FIG. 1 is a schematic perspective view in cross section of a system for extinguishing a fire and preventing the fire from restarting according to the invention, in the configuration installed around an electric vehicle, with a connection to a fire truck that serves as device for supplying water for immersing at least the battery pack of the vehicle.

FIG. 2 is a view from above showing the self-supporting structure of a system according to the invention, in the configuration installed around an electric vehicle.

### DETAILED DESCRIPTION

The terms “lower”, “upper”, “top” and “bottom” are to be understood with reference to a self-supporting structure in the inflated and installed configuration, extending vertically and creating a peripheral barrier that is closed upon itself.

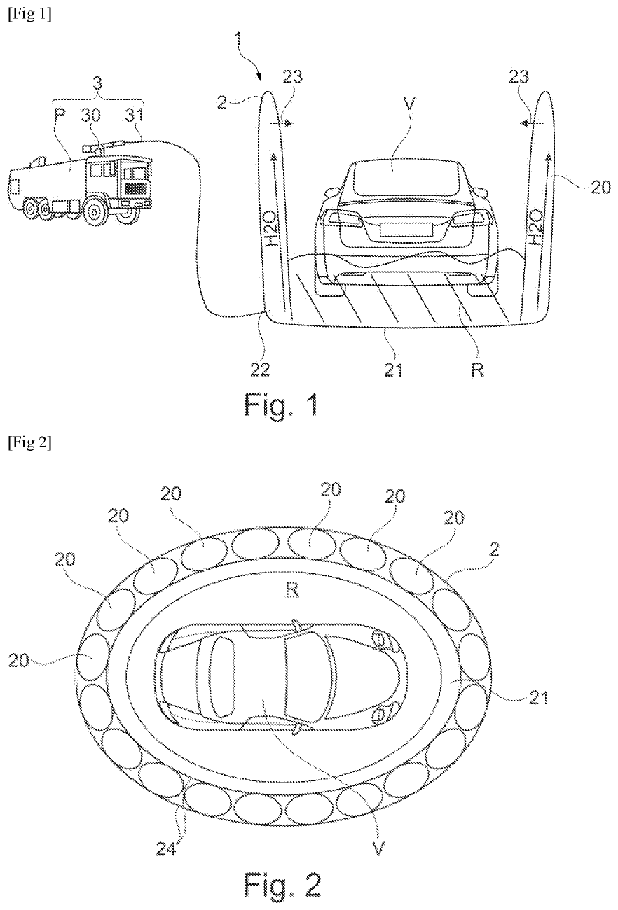

FIGS. 1 and 2 show a system 1 according to the invention for extinguishing a fire in an electric vehicle and preventing any fire from restarting in this vehicle.

The system 1 comprises a self-supporting structure 2 made up of a plurality of aligned flexible casings, each closed upon itself, in the form of sausages 20, the sausages being fluidly interconnected at the bottom.

The sausages 20 are spaced apart regularly, so as to ensure uniform inflation.

The structure 2 further comprises a flexible sealing sheet 21 that extends from the bottom of the sausages 20 so as to follow the ground covering as closely as possible. The sausages 20 and the sheet 21 are advantageously made of a fabric based on aramid fibers and coated, at least on the inside intended to face the vehicle V, with a polytetrafluoroethylene (PTFE) film.

The flexible sealing sheet 21 extends along a curved line that is not closed upon itself, which facilitates installation of said sheet 21 around the vehicle V. Once installed, the sheet 21 extends from the bottom of the sausages 20 toward the vehicle V without being arranged under this vehicle V. Thus, it is not necessary to move the vehicle V to put the sheet 21 in place.

At least some of the sausages 20 comprise, at the bottom, a supply hole 22 which is connected to a water supply device 3. As shown in FIG. 1, this supply device 3 may be a fire truck P connected to the supply hole 22 from a deluge gun 30 via a special hose 31. At least some of the sausages 20 also comprise, at the top, an outlet hole 23.

Fastening means 24, such as fastening straps, that may include covering sheets for improving lateral sealing, arranged around the plurality of sausages closed upon itself, ensure mechanical retention so as to create the peripheral barrier closed upon itself. The system works as follows.

Step i/: An emergency responder, in particular a fire fighter, positions the structure 2 with sausages 20 around an electric vehicle which is on fire or in which a fire has just been put out. The emergency responder also positions the sealing sheet 21 on the ground on the inside of the periphery of the structure, i.e. such that it extends toward the electric vehicle. By putting in place the fastening straps and possibly the sheet 24, the structure 2 can be closed upon itself around the vehicle V.

Steps ii/ and iii/: once the water supply device 3 has been connected to the supply hole 22 of the sausages 20, the latter are filled with water.

This first of all inflates the sausages 20, which deploy vertically and make the structure 2 self-supporting while creating a peripheral barrier around the vehicle V, which delimits an internal volume or tank R.

When the water reaches the outlet hole(s) 23, it overflows from the sausages into the tank R. As the tank R is moreover sealed, specifically by virtue of the sheet 21, it thus fills with water. Note that the seal sought may not be perfect, but it is enough that the rate of leakage through the barrier created by the self-supporting inflated structure 2 is lower than the rate of intake of water.

The sheet 21 presses on the underlying ground, under the body of liquid contained in the tank R and the weight of the liquid contained in the sausages 20. The sheet 21 thus enhances the seal of the peripheral barrier and limits leakage of liquid from beneath the sausages 20.

The tank R is filled until at least the module or battery pack fitted inside the vehicle V is immersed.

Such immersion ensures without fail the electrical discharge of the module or battery pack of the vehicle V, thereby preventing any fire from starting or restarting.

Soluble salts may be placed in the system. Once these salts have been dissolved by the water supplied, they promote more efficient and quicker discharge of the module or battery pack. They may be solid NaCl salts, for example.

These salts may be added to the tank R by the users, for example the fire fighters, once the inflatable structure has been put in place and before or during filling thereof. To avoid this addition step and thus simplify the emergency response operation, these salts may also be already present in solid form in the collapsed structure, before it is deployed and inflated; for example, they may be placed in the liner (skirt) or on the outer face of the sausages forming part of the space R and in contact with the filling water. If the tank is filled with water by overflow from the peripheral sausages 20, the salts may be placed directly inside the sausages 20. In this case, the salts are dissolved as the sausages are filled with water, this solution then spilling into the tank R through the upper openings 24 in the sausages.

Further variants and improvements may be envisaged without exceeding the scope of the invention.

For example, if, in all the examples shown, the self-supporting inflatable structure is made up of a plurality of sausages inflated using water for immersing the battery pack of the electric vehicle, any other inflatable structure for creating a peripheral barrier that can be placed easily around the vehicle and can be inflated, either with air or with a liquid that also serves to immerse the battery pack, can also easily be used.

1. A system for at least one of extinguishing a fire and preventing a fire from starting or restarting in an electric vehicle including a module or a battery pack comprising a plurality of electrochemical batteries, the system comprising:
a self-supporting inflatable structure, the shape and dimensions of which when deployed are configured to create a peripheral barrier that is closed upon itself, around the electric vehicle, the inflatable structure comprising a plurality of aligned flexible casings, each closed upon itself, in the form of sausages, the sausages being fluidly interconnected at the bottom, and deploying vertically when they are inflated; and
a liquid supply device configured to fill, at least partially, the volume delimited inside the peripheral barrier, so as to immerse at least the module or battery pack in the liquid.

2. The system according to claim 1, wherein the structure comprises at least one filling hole for filling with liquid for inflation.

3. The system according to claim 2, wherein the filling hole is configured to connect to the liquid supply device.

4. The system according to claim 3, wherein at least some of the sausages comprise an outlet hole at the top, such that when deployed vertically, after being inflated with the liquid, the liquid fills, by overflowing from the sausages, the volume delimited inside the barrier.

5. The system according to claim 1, wherein the sausages are spaced apart regularly, so as to ensure uniform inflation and hence a uniform barrier around the whole periphery thereof.

6. The system according to claim 1, further comprising fastening means arranged around the plurality of sausages closed upon itself, for mechanical retention so as to create the peripheral barrier.

7. The system according to claim 6, wherein the fastening means comprise covering sheets configured to cover at least partially the gaps between the sausages after the sausages have been deployed.

8. The system according to claim 1, wherein the inflatable structure further comprises a flexible sealing sheet that extends from the bottom of the sausages and, in the installed configuration, toward an inside of the barrier.

9. The system according to claim 1, wherein the liquid for filling the volume is water.

10. The system according to claim 8, further comprising salts that are soluble in water, placed beforehand in at least one area of the structure in the non-deployed state so that said salts are in contact with the water when the sealed volume is filled.

11. The system according to claim 1, wherein the inflatable structure is at least partially made of a fabric based on aramid fibers.

12. The system according to claim 10, wherein the fabric is sealed, at least on an inside intended to be in contact with the liquid, by a polytetrafluoroethylene film.

13. The system according to claim 1, wherein the liquid supply device is a fire-fighting vehicle, a tank truck, or an emergency response vehicle.

14. A method of operation of the system of claim 1, the method comprising:
positioning the inflatable structure and closing the inflatable structure around an electric vehicle;
inflating the structure so as to create the peripheral barrier; and
filling, with a liquid from the supply device, at least part of the volume delimited inside the peripheral barrier, so as to immerse at least the module or battery pack.

15. The method according to claim 14, wherein the inflating and filling steps are performed one after the other using just the supply device, and the filling step is performed by overflowing from the structure once the structure has been inflated.

16. The method according to claim 14, further comprising using water as the filling liquid for the filling step.
